(19) United States
(12) Patent Application Publication
(10) Pub. No.: US 2008/0226901 A1
(43) Pub. Date: Sep. 18, 2008

(54) Paints Containing Particles

(75) Inventors: Volker Stanjek, Ampfing (DE); Felicitas Schauer, Aying (DE); Christoph Briehn, Munich (DE); Juergen Pfeiffer, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/996,417

(22) PCT Filed: Jun. 29, 2006
(86) PCT No.: PCT/EP06/06324

§ 371 Date: Feb. 14, 2008

(30) Foreign Application Priority Data
Jul. 22, 2005 (DE) 10 2005 034 347.3

(51) Int. Cl. B32B 27/40

(52) U.S. Cl. 428/334

(57) ABSTRACT

Coating formulations of improved scratch resistance suitable for use in automotive clear and top coatings contain a functional group-containing film forming resin, a curative having functional groups reactive with the film forming resin, and particles having functional groups reactive with at-least one of the functional groups of the resin or the curative, the particles functionalized with an organosilane of the formulae

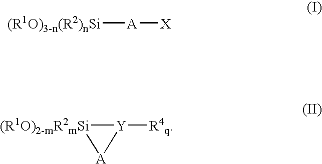

The invention relates to particle-containing coatings which on their surface possess a higher concentration of particles then in their interior and to their use.

Coating systems comprising particles—more particularly nanoparticles—are state of the art. Such coatings are described for example in EP 1 249 470, WO 03/16370, US 20030194550 or US 20030162015. The particles in these coatings lead to an improvement in the properties of the coatings, and more particularly with regard to their scratch resistance and also, where appropriate, their chemical resistance.

A frequently occurring problem associated with the use of the—generally inorganic—particles in organic coating systems consists in a usually inadequate compatibility between particle and coating-material matrix. This can lead to the particles being insufficiently dispersible in a coating-material matrix. Moreover, even well-dispersed particles may undergo settling in the course of prolonged standing or storage times, with the formation, possibly, of larger aggregates or agglomerates, which even on redispersion are then impossible or difficult to separate into the original particles. The processing of such inhomogeneous systems is extremely difficult in any case, and in fact is often impossible. Coating materials which, once applied and cured, possess smooth surfaces are preparable by this route generally not at all or only in accordance with cost-intensive processes.

It is therefore favorable to use particles which on their surface possess organic groups which lead to improved compatibility with the coating-material matrix. In this way the inorganic particle becomes “masked” by an organic shell. Particularly favorable coating-material properties can be achieved in this context if, furthermore, the organic functions on the particle surfaces are reactive toward the coating-material matrix so that under the respective curing conditions of the coating material in question they are able to react with the matrix. In this way, success is achieved in incorporating the particles into the matrix chemically in the course of coating-material curing, which often results in particularly good mechanical properties but also an improved chemical resistance. Systems of this kind are described for example in DE 102 47 359 A1, EP 832 947 A or EP 0 872 500 A1. A disadvantage of the systems described there are the generally relatively high levels of the comparatively expensive nanoparticles as a proportion of the coating material's overall solids content.

Also known, furthermore, is the use of coatings which comprise a binder which has been modified with nanoparticles. These coatings can be produced by reacting the particles, equipped with a reactive functionality, with a binder containing a complementary function. In this case, therefore, the organofunctional particle is incorporated chemically into the coating-material matrix not only at the coating-material curing stage but also even at the binder preparation stage. Systems of this kind are described for example in EP 1 187 885 A or WO 01/05897. They possess the disadvantage, however, of being relatively complicated to prepare, leading to high preparation costs.

In the case of one particularly important type of coating material, a film-forming resin is used which comprises hydroxyl-functional prepolymers, and more particularly hydroxyl-functional polyacrylates and/or polyesters, which on curing of the coating material are reacted with an isocyanate-functional curative (polyurethane coating materials) and/or with a melamine curative (melamine coating materials). The polyurethane coating materials are notable for particularly good properties. For instance, polyurethane coating materials possess in particular a superior chemical resistance, while the melamine coating materials generally possess better scratch resistances. These types of coating material are typically used in particularly high-value and demanding fields of application: for example, as clearcoat and/or topcoat materials for OEM paint systems in the automobile and vehicle industry. The majority of topcoat materials for automotive refinish also consist of systems of this kind. The film thicknesses of these coatings are typically situated in ranges from 20 to 50 μm.

In the case of the polyurethane coating systems, a distinction is generally made between what are called the 2K and the 1K systems. The former consist of two components, of which one is composed essentially of the isocyanate curative, while the film-forming resin with its isocyanate-reactive groups is contained in the second component. Both components in this case must be stored and transported separately and should not be mixed until shortly before they are processed, since the pot life of the completed mixture is greatly limited. Often more favorable, therefore, are the 1K systems, which consist of only one component, in which alongside the film-forming resin there is a curative with protected isocyanate groups. 1K coating materials are cured thermally, the protective groups of the isocyanate units being eliminated, with the deprotected isocyanates being able then to react with the film-forming resin. Typical baking temperatures of such 1K coating materials are 120-160° C. Melamine coating materials are generally 1K coating materials; the baking temperatures are typically situated in a comparable temperature range.

In the case of these high-value coating materials in particular, a further improvement in properties would be desirable. This is true more particularly of vehicle finishes. For instance, the attainable scratch resistance of conventional auto finishes, in particular, is still not sufficient, with the consequence, for example, that particles in the wash water in a car wash lead to significant marring of the finish. Over time, this causes lasting damage to the gloss of the finish. In this situation, formulations that allowed better scratch resistances to be achieved would be desirable.

One particularly advantageous way of achieving this object is to use particles having, on their surface, organic functions which are reactive toward the film-forming resin or else toward the curative. Moreover, these organic functions on the particle surface lead to masking of the particles and thus enhance the compatibility between particles and coating-material matrix.

Particles of this kind with suitable organic functions are already known in principle. They and their use in coatings are described for example in EP 0 768 351, EP 0 832 947, EP 0 872 500 or DE 10247359.

The scratch resistance of coatings can in fact be increased significantly through the incorporation of this kind of particles. However, in all of the methods of using these particles that have been described in the prior art, optimum results have still not been achieved. In particular, the corresponding coatings have such high particle contents that on grounds of cost alone it would be difficult to realize the use of such coating materials in large-scale production-line coating systems.

WO 01/09231 describes particle-containing coating systems characterized in that there are more particles located in a surface segment of the coating material than in a bulk segment. An advantage of this particle distribution is the comparatively low particle concentration which is needed for a marked improvement in scratch resistance. The desired high affinity of the particles for the surface of the coating material is achieved by applying a surface-active silicone resin agent to the particle surfaces. The modified particles obtainable in this way possess the relatively low surface energy often typical of silicones. As a consequence of this they arrange themselves preferentially at the surface of the film-forming matrix. A disadvantage of this method, however, is the fact that not only the silicone-resin modification of the particles but also the preparation of the silicone resins themselves that are required for that purpose are costly and complicated from a technical standpoint. A particular problem associated with the preparation of the silicone resins is the fact that the attainment of effective scratch resistance requires the silicone resins to be provided with organic functions, carbinol functions for example, via which the particles thus modified can be incorporated chemically into the coating material when the latter is cured. Silicone resins functionalized in this way are available commercially not at all or only to a very restricted degree. In particular, however, the selection of organic functions that are possible at all in the case of this system is relatively limited. For this system, therefore, as also for all of the other prior-art systems, optimum results have still not been achieved.

It was an object of the invention, therefore, to develop a coating system that overcomes the disadvantages of the prior art.

The invention provides coatings (B) produced from coating formulations (B1) which comprise
a) 20%-90% by weight, based on the solids fraction, of a film-forming resin (L) having reactive groups,
b) 0%-90% by weight, based on the solids fraction, of a coating curative (H) which possesses reactive functions with which it is able, during curing of the coating material, to react with the reactive groups of the film-forming resin (L),
c) 0.05%-15% by weight, based on the solids fraction, of particles (P), and
d) 0%-90% by weight, based on the overall coating formulation (B1), of a solvent or of a mixture of solvents,

wherein
a) the cured coating (B) has, aa) on its surface or ab) in the near-surface layers which measured from the surface are 1000 nm thick, or ac) both on its surface and in the near-surface layers which measured from the surface are 1000 nm thick, a higher concentration of the particles (P) than in its interior, and wherein
b) the particles (P) are obtainable by reaction of colloidal metal oxide or silicon oxide sols (P1) with organosilanes (A) selected from the general formula (I) and (II)

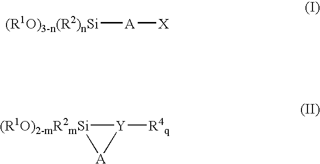

where
R¹ denotes hydrogen or alkyl, cycloalkyl or aryl radicals having in each case 1 to 6 C atoms, it being possible for the carbon chain to be interrupted by nonadjacent oxygen, sulfur or NR³ groups,
R² denotes alkyl, cycloalkyl, aryl or arylalkyl radicals having in each case 1 to 12 C atoms, it being possible for the carbon chain to be interrupted by nonadjacent oxygen, sulfur or NR³ groups,
R³ denotes hydrogen or alkyl, cycloalkyl, aryl, arylalkyl, aminoalkyl or aspartate ester radicals,
R⁴ denotes hydrogen or any desired organic radical,
A denotes a divalent, optionally substituted alkyl, cycloalkyl or aryl radical having 1-10 carbon atoms, which optionally may be interrupted by oxygen, sulfur or NR³ groups,
X denotes an organic function which on curing of the coating is able to enter into a chemical reaction with functions of the film-forming resin (L) and/or of the curative (H), and
Y denotes an organic function which when the coating material is cured—where appropriate after the cleaving of the Si—Y bond—is able to enter into a chemical reaction with functions of the film-forming resin (L) and/or of the curative (H), and
n is able to adopt the values 0, 1 or 2,
m is able to adopt the values 0, 1 or 2, and
q is able to adopt the values 0 or 1.

The solids fraction referred to comprises those components of the coating material which remain in the coating material when the latter is cured.

The accumulation of the particles at the surface and/or in the near-surface layers is preferably confined to the top 500 nm or 200 nm and with particular preference to the uppermost 100 nm of the coatings (B).

The invention is based on the finding that the particles (P), when the coating material is applied and cured, adopt a preferentially disposition at or near the surface of the coating (B) of the invention. This finding is especially remarkable since the silane modification of the particles (P) means that the particles at their surfaces have reactive organic groups—for example, hydroxyl functions, primary or secondary amine functions, isocyanate functions, protected isocyanate functions. These relatively polar organic functions commonly do not lead to surfaces having particularly low surface energies. A preferential automatic disposition of the particles at or near the coating surface, therefore, was not expected; for the skilled person, the near-surface distribution of the particles (P) in the coating (B) is completely surprising.

The near-surface distribution of the particles (P) in the cured coating (B) has the consequence that, when the particles (P) are employed in coating systems, the change in the scratch resistance of the resulting coating (B) is not proportional to the concentration of the particles employed. On the contrary, therefore, even small or very small amounts of particles (P) are sufficient to bring about a distinct improvement in the scratch resistance of the coatings (B), whereas even by means of higher fractions—in some cases much higher—of particles (P) it is not possible to bring about any further significant increase in the scratch resistance.

The small amounts of the particles (P), which are usually relatively expensive, on the one hand allow the comparatively inexpensive production of coatings of high scratch resistance, while on the other hand the low particle amounts reduce the—possibly negative—influences of the particles on other film properties, such as elasticity, transparency or surface smoothness, for example. Accordingly the coating (B) of the invention with low levels of particles which are readily accessible through synthesis constitutes a great advantage over the prior art.

The inventive accumulation of the particles at the surface comes about preferably as a result of an automatic disposition of the particles. In other words, when the coating formulation (B1) of the invention is applied, there is no need for special process steps—such as, for example, the application of different coating films each with different particle concentrations, or aftertreatment of the applied coating with a particle dispersion—in order to achieve the inventive particle distribution.

The coating formulations (B1) which can be processed to the coatings (B) of the invention are likewise provided by the present invention.

The film-forming resin (L) and the coating curative (H) preferably possess a sufficient number of reactive groups for a three-dimensional polymer network to form when the coating formulation (B1) is cured. The film-forming resin (L) preferably comprises a hydroxyl-functional (pre)polymer, more preferably hydroxyl-functional polyacrylates and/or polyesters. The coating curative (H) contains preferably protected and/or unprotected isocyanate groups and/or comprises melamine-formaldehyde resins.

In one preferred embodiment of the invention the coatings (B) are produced from coating formulations (B1) which contain
a) 30%-80% by weight, based on the solids fraction, of the film-forming resin (L),
b) 5%-60% by weight, based on the solids fraction, of the coating curative (H),
c) 0.1%-12% by weight, based on the solids fraction, of particles (P), and
d) 0%-70% by weight, based on the overall coating formulation (B1), of a solvent or mixture of solvents.

With particular preference the coating formulations (B1) contain
a) 40%-70% by weight, based on the solids fraction, of the film-forming resin (L),
b) 15%-50% by weight, based on the solids fraction, of the coating curative (H),
c) 0.5%-8% by weight, based on the solids fraction, of particles (P), and
d) 10%-60% by weight, based on the overall coating formulation (B1), of one or more solvents.

The fraction of the solvent or solvents as a proportion of the overall coating formulation (B1) is more preferably 10% to 50% by weight.

The processing of the coating formulations (B1) to give the coatings (B) of the invention typically takes place by means of the following worksteps: coating of the substrate, drying, and curing; the last two steps, particularly in the case of 2K [two-component] coating materials, may also take place simultaneously.

The amount of particles (P) in the coating (B) is preferably 0.1%-12% by weight, based on the solids fraction, more preferably 0.2%-8% by weight. In especially advantageous embodiments of the invention the amount of particles (P) is 0.5%-5% by weight, based on the solids fraction, more particularly 0.7%-3% by weight.

The coatings (B) of the invention are used preferably as clearcoat and/or topcoat materials, more particularly for automotive OEM finishes or automotive refinishes.

In the organosilanes (A) the groups R¹ are preferably methyl or ethyl radicals. The groups R² are preferably alkyl radicals having 1-6 carbon atoms or phenyl radicals, and more particularly are methyl, ethyl or isopropyl radicals. R³ has preferably not more than 10 carbon atoms, more particularly not more than 4 carbon atoms. R⁴ is preferably hydrogen or an alkyl radical having 1-10, with particular preference having 1-6, carbon atoms, more particularly methyl or ethyl radicals. A is preferably a divalent radical having 1-6 carbon atoms, which may where appropriate be interrupted by oxygen, sulfur or NR³ groups. With particular preference A is a (CH₂)₃ group or a CH₂ group.

In one preferred embodiment of the invention the organosilanes (A) used are compounds of the general formula (I) in which the function X represents an isocyanate function or, with particular preference, a protected isocyanate function. The latter function releases an isocyanate function on thermal treatment. The preferred elimination temperatures of the protective groups are 80 to 200° C., with particular preference 100 to 170° C. Protective groups which can be used include secondary or tertiary alcohols, such as isopropanol or tert-butanol, CH-acidic compounds, such as diethyl malonate, acetylacetone, ethyl acetoacetate, oximes, such as formaldoxime, acetaldoxime, butane oxime, cyclohexanone oxime, acetophenone oxime, benzophenone oxime or diethylene glyoxime, lactams, such as caprolactam, valerolactam, butyrolactam, phenols, such as phenol, o-methylphenol, N-alkyl amides, such as N-methylacetamide, imides, such as phthalimide, secondary amines, such as diisopropylamine, imidazole, 2-isopropylimidazole, pyrazole, 3,5-dimethylpyrazole, 1,2,4-triazole, and 2,5-dimethyl-1,2,4-triazole, for example. Preference here is given to using protective groups such as butane oxime, 3,5-dimethylpyrazole, caprolactam, diethyl malonate, dimethyl malonate, acetoacetate, diisopropylamine, pyrrolidone, 1,2,4-triazole, imidazole, and 2-isopropylimidazole. Particular preference is given to using protective groups which allow a low baking temperature, such as diethyl malonate, dimethyl malonate, butane oxime, diisopropylamine, 3,5-dimethylpyrazole and 2-isopropyl-imidazole, for example.

The corresponding particles (P) with protected isocyanate groups are used preferably in coating formulations (B1) which as curative (H) comprise a compound which likewise possesses protected isocyanate functions. The corresponding coating formulations (B1) are therefore 1K [one-component] polyurethane coating materials. In a particularly preferred embodiment of the invention the protected isocyanate groups of the particles (P) in these coating formulations (B1)—or at least a majority of them—bear protective groups which have a lower elimination temperature than all or at least the majority of the protective groups of the protected isocyanate groups of the coating curative (H).

X is preferably a hydroxyl or thiol function, a group of the formula NHR⁵, a heterocyclic ring containing an NH function, or an epoxide ring. R⁵ has the definition of R³. If X is an epoxide ring, then it is opened, before, during or after the reaction of the silane (A) with the particles (P1), by means of a suitable method, as by a reaction with ammonia, an amine, water or an alcohol or an alkoxide, for example.

Where silanes (A) of the general formula (II) are used in the preparation of the particles (P), the ring structure of this silane is opened, during particle preparation, by the attack of a hydroxyl group of the particles (P1) on the silicon atom of the silane (A), with cleavage of the Si—Y bond. Y in this case is preferably a function which, following this cleavage of the Si—Y bond, represents a hydroxyl or thiol function or a group of the formula NHR⁵.

Particular preference is given in this context to using organosilanes (A) which conform to the general formulae (III) or (IIIa)

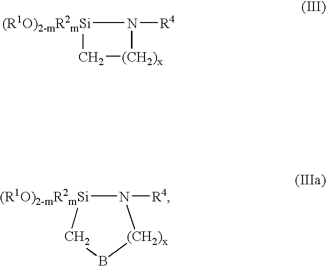

where
B is an oxygen atom, a sulfur atom, a carbonyl group, an ester group, an amide group or a group NR⁶,
R⁶ has the definitions of R³,
x can adopt the values from 0 to 10,

and the remaining variables have the definitions given for the general formulae (I) and (II).

In a further particularly preferred embodiment of the invention the particle sols (P1) are functionalized with organosilanes (A) which conform to the general formulae (IV) or (IVa)

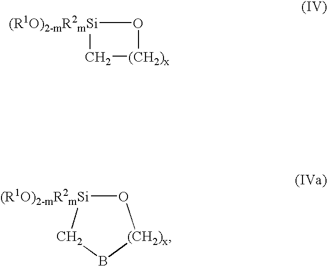

where all of the variables have the definitions given for the general formulae (I)-(III).

Very particular preference is given to using, as organosilanes (A), compounds of the general formulae (V) or (VI)

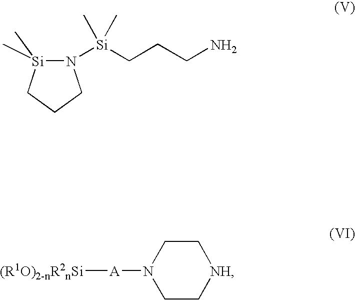

where all of the variables have the definitions given above.

In the preparation of the particles (P) it is possible, for the surface modification of the particle sols (P1), to make use not only of the silanes (A) but also of any desired mixtures of the silanes (A) with other silanes (S1), silazanes (S2) or siloxanes (S3). The silanes (S1) possess either hydroxysilyl groups or else hydrolyzable silyl functions, the latter being preferred. These silanes may additionally possess further organic functions, although silanes (S1) without further organic functions can also be used. Silazanes (S2) and siloxanes (S3) used are with particular preference hexamethyldisilazane and hexamethyldisiloxane, respectively. The weight fraction of the silanes (A) as a proportion of the total amount formed by the silanes (A) and (S1), silazanes (S2), and siloxanes (S3), is preferably at least 50% by weight, more preferably at least 70% by weight or 90% by weight. In one further particularly preferred embodiment of the invention no compounds (S1), (S2) or (S3) are used at all.

The particles (P) are prepared starting from colloidal silicon oxide or metal oxide sols (P1), which in general take the form of a dispersion of the corresponding oxide particles of submicron size in an aqueous or nonaqueous solvent. In this case the oxides that can be used include those of the metals aluminum, titanium, zirconium, tantanum, tungsten, hafnium, and tin. Particular preference is given to using colloidal silicon oxide. This, generally, is a dispersion of silicon dioxide particles in an aqueous or nonaqueous solvent. In general the silica sols are 1%-50% strength by weight solutions, preferably a 20%-40% strength by weight solution. Typical solvents are, besides water, more particularly alcohols, especially alcohols having 1 to 6 carbon atoms—frequently isopropanol but also other alcohols, usually of low molecular mass, such as methanol, ethanol, n-propanol, n-butanol, isobutanol, and tert-butanol, for example, where the average particle size of the silicon dioxide particles (P1) is 1-100 nm, preferably 5-50 nm, more preferably 8-30 nm.

The preparation of the particles (P) from the colloidal silicon oxides or metal oxides (PI) and the organosilanes (A) takes place preferably directly when the reactants are mixed—where appropriate in the presence of further solvents and water. The sequence of addition of the individual reactants is arbitrary. Preferably, however, the silanes (A)—where appropriate in a solvent and/or in mixtures with other silanes (S1), silazanes (S2) or siloxanes (S3)—are added to the aqueous or organic particle sol (P1). This sol is, where appropriate, stabilized acidically, as by hydrochloric or trifluoroacetic acid, for example, or basically, as by ammonia, for example. The reaction takes place in general at temperatures of 0-200° C., preferably at 20-80°, and more preferably at 20-60° C. The reaction times are typically 5 minutes to 48 hours, preferably 1 to 24 hours. Optionally it is also possible to add acidic, basic or heavy-metal catalysts. With preference, however, no separate catalysts at all are added.

Since the colloidal silicon oxide or metal oxide sols (P1) often take the form of an aqueous or alcoholic dispersion, it may be advantageous to replace the solvent or solvents, during or after the preparation of the particles (P), by another solvent or by another solvent mixture. This can be done, for example, by distillative removal of the original solvent, with it being possible for the new solvent or solvent mixture to be added in one step or else in two or more steps before, during or else not until after the distillation. Suitable solvents in this context may include, for example, water, aromatic or aliphatic alcohols, preference being given to aliphatic alcohols, more particularly to aliphatic alcohols having 1 to 6 carbon atoms (e.g., methanol, ethanol, n-propanol, isopropanol, n-butanol, isobutanol, tert-butanol, the various regioisomers of pentanol and of hexanol), esters (e.g. ethyl acetate, propyl acetate, butyl acetate, butyl diglycol acetate, methoxypropyl acetate), ketones (e.g. acetone, methyl ethyl ketone), ethers (e.g. diethyl ether, tert-butyl methyl ether, THF), aromatic solvents (toluene, the various regioisomers of xylene, and also mixtures such as solvent naphtha), lactones (e.g. butyrolactone, etc.) or lactams (e.g. N-methylpyrrolidone). Preference is given here to aprotic solvents or to solvent mixtures which consist exclusively or else at least in part of aprotic solvents. Aprotic solvents are of advantage, at least in the context of use in isocyanate-curing coating formulations (B1), i.e., in 1K or 2K polyurethane coating materials, since protic solvents, like water, are reactive toward isocyanate functions, a fact which can lead to unwanted side-reactions between curative (H) and the solvent. As well as the preparation of a particle dispersion, consideration can also be given to isolating the particles (P) in solid form, by means, for example, by the distillative removal of the solvent/solvents following particle preparation.

In the case of one particularly advantageous embodiment of the invention the particles (P) are prepared using organic silanes (A) of the general formula (I) or (VI) in which the spacer A stands for a CH₂ bridge, or else cyclic organosilanes of the general formulae (III), (IIIa), (IVa) or (V). These silanes are notable for a particularly high level of reactivity toward the hydroxyl groups of the particles (P1), so that the functionalization of the particles can be carried out particularly quickly and at low temperatures, more particularly even at room temperature.

Where organosilanes (A) are used that only possess monofunctional silyl functions, i.e., silanes of the general formulae (I), (II), (III), (IIIa), (IV), (IVa), or (VI) with n and/or m=2, then there is no need to add water when preparing the particles (P), since the monoalkoxysilyl groups/the reactive cyclic silanes are able to react directly with the hydroxyl functions on the surface of the particles (P1). Where, in contrast, silanes (A) having difunctional or trifunctional silyl groups are used, i.e., silanes of the general formulae (I), (II), (III), (IIIa), (IV), (IVa) or (VI) with n and/or m=0 or 1), then the presence or addition of water during the preparation of the particles (P) is often advantageous, since in that case the alkoxysilanes are able to react not only with the Si—OH functions of the particles (P1) but also—after their hydrolysis—with one another. This produces particles (P) which possess a shell composed of intercrosslinked silanes (A).

The film-forming resins (L) included in the coating formulations (B1) are composed preferably of hydroxyl-containing prepolymers, more preferably of hydroxyl-containing polyacrylates or polyesters. Hydroxyl-containing polyacrylates and polyesters of this kind that are suitable for coating-material preparation are sufficiently well known to the skilled worker and are widely described in the relevant literature. They are produced and sold commercially by numerous manufacturers.

The coating formulations (B1) may be one-component (1K) or else two-component (2K) coating materials. In the first case, the coating curatives (H) used are preferably melamine curatives, tris(amino-carbonyl)triazines and/or curatives which possesses protected isocyanate groups. In the second case, the curatives (H) used are preferably compounds having free isocyanate groups. Not only melamine curatives but also curatives with protected or unprotected NCO groups are well-known, as state of the art, and are widely described in the relevant literature. They too are available commercially and are sold by numerous manufacturers.

In one preferred embodiment of the invention the coating curative (H) contains free or protected isocyanates groups. Usually for this purpose use is made of common di- and/or polyisocyanates, which where appropriate have been provided beforehand with the respective protective groups. In this case it is possible in principle to use all customary isocyanates of the kind widely described in the literature. Common diisocyanates are, for example, diisocyanatodiphenyl-methane (MDI), not only in the form of crude or technical MDI but also in the form of pure 4,4′- and/or 2,4′-isomers or mixtures thereof, tolylene diisocyanate (TDI) in the form of its different regioisomers, diisocyanatonaphthalene (NDI), isophorone diisocyanate (IPDI), perhydrogenated MDI (H-MDI), tetramethylene diisocyanate, 2-methylpentamethylene diisocyanate, 2,2,4-trimethylhexamethylene diisocyanate, dodeca-methylene diisocyanate, 1,4-diisocyanatocyclohexane, 1,3-diisocyanato-4-methylcyclohexane or else hexamethylene diisocyanate (HDI). Examples of polyisocyanates are polymeric MDI (P-MDI), triphenylmethane triisocyanate, and also all isocyanurate trimers or biuret trimers of the diisocyanates listed above. In addition it is also possible to use further oligomers of the abovementioned isocyanates with blocked NCO groups. All of the di- and/or polyisocyanates may be used individually or else in mixtures. Preference is given to using the isocyanurate trimers and biuret trimers of the comparatively UV-stable aliphatic isocyanates, with particular preference the trimers of HDI and IPDI.

Where isocyanates with protected isocyanate groups are used as coating curatives (H), suitable protective groups are the same compounds as already described in the context of the description of particles (P) modified with protected isocyanates. The ratio of isocyanate groups—blocked or otherwise—of all of the ingredients for coating formulation (B1) to the isocyanate-reactive groups of all of the ingredients of the coating formulation (B1) is typically from 0.5 to 2, preferably from 0.8 to 1.5, and with particular preference from 1.0 to 1.2.

It will be appreciated that the organic functions of the silanes to be used for particle modification (i.e., the functions X and Y in the general formulae (I) and (II), respectively, the functions of the film-forming resin (L) and also of the curative (H)) should be harmonized with one another in an appropriate way.

It is possible, furthermore, for the coating formulations (B1) further to comprise the common solvents and also the additives and coating components that are typical in coating formulations, as a component (E). Instances of these might include flow control assistants, surface-active substances, adhesion promoters, light stabilizers such as UV absorbers and/or free-radical scavengers, thixotroping agents, and further solids. Additions of this kind are preferably added in order to produce the particular profiles of properties that are desired both in the coating formulations (B1) and also in the cured coatings. The coating formulations (B1) may also comprise pigments.

In the case of one preferred process the coating formulations (B1) of the invention are produced by adding the particles (P), during the mixing operation, in the form of a powder or a dispersion, in a suitable solvent. In addition, however, a further process is preferred wherein first of all a masterbatch is produced from the particles (P) and from one or more coating components, having particle concentrations >15% by weight, preferably >25% by weight, and more preferably >30% by weight. In the preparation of the coating formulations (B1) of the invention, this masterbatch is then mixed with the remaining coating-material components. Where a particle dispersions forms the starting point for the preparation of the masterbatch, it can be advantageous for the solvent of the particle dispersion to be removed in the course of the masterbatch preparation process, by way of a distillation step, for example, or else replaced by another solvent or solvent mixture.

The coatings (B) of the invention can be used to coat any desired substrates for the purpose of enhancing the scratch resistance, abrasion resistance or chemical resistance. Preferred substrates are plastics, such as polycarbonate, polybutylene terephthalate, polymethyl methacrylate, polystyrene or polyvinyl chloride, and also basecoat materials applied in an upstream step.

With particular preference the coatings (B) serve as scratch-resistant clearcoat or topcoat materials, more particularly in the vehicle industry. The coating formulations (B1) can be applied by any desired methods such as immersion, spraying, and pouring methods. Also possible is the application of the coating formulation (B1) to a basecoat by a wet in wet process. Curing is generally accomplished by heating under the particular conditions required (2K coating materials typically at 0-100° C., preferably at 20-80° C.; 1K coating materials at 100-200° C., preferably at 120-160° C.). It will be appreciated that curing of the coating material may be accelerated through the addition of suitable catalysts. Suitable catalysts in this case are more particularly acidic compounds, basic compounds, and compounds containing heavy metals.

All of the symbols in the above formulae have their definitions in each case independently of one another. In all of the formulae the silicon atom is tetravalent.

Unless indicated otherwise, all quantity and percentage figures are based on the weight, all pressures are 0.10 MPa (abs.), and all temperatures are 20° C.

### EXAMPLES

### Synthesis Example 1

### Preparation of an Alkoxysilane Having Diisopropylamine-Protected Isocyanate Groups (Silane 1)

86.0 g of diisopropylamine and 0.12 g of Borchi® catalyst (catalyst VP 0244 from Borchers GmbH) are introduced and heated to 80° C. Over the course of 1 h 150.00 g of isocyanatomethyltrimethoxysilane are added dropwise and the mixture is stirred at 60° C. for 1 h. ¹H NMR and IR spectroscopy show that the isocyanato-silane has been fully converted.

### Synthesis Example 2

### Preparation of an Alkoxysilane Having Diisopropylamine-Protected Isocyanate Groups (Silane 2)

74.5 g of diisopropylamine and 0.12 g of Borchi® catalyst (catalyst VP 0244 from Borchers GmbH) are introduced and heated to 80° C. Over the course of 1 h 150.00 g of 3-isocyanatopropyltrimethoxysilane are added dropwise and the mixture is stirred at 60° C. for 1 h. ¹H NMR and IR spectroscopy show that the isocyanatosilane has been fully converted.

### Synthesis Example 3

### Preparation of SiO₂ Nanosol Particles Modified with Blocked Isocyanate Groups

1.40 g of the diisopropylamine-protected isocyanato-silane (silane 1) prepared in synthesis example 1 are dissolved 1.0 g of isopropanol. Then, over the course of 30 min, 20 g of an SiO₂ organosol (IPA-ST from Nissan Chemicals, 30% by weight SiO₂, 12 nm average particle diameter) are added dropwise and the pH is adjusted to 3.5 by addition of trifluoroacetic acid. The dispersion obtained is stirred at 60° C. for 3 h and then at room temperature for 18 h. Thereafter, 18.1 g of methoxypropyl acetate are added. The mixture is stirred for a few minutes and then a major part of the isopropanol is distilled off at 70° C. In other words, distillation is continued until the nanoparticle sol has been concentrated to 29.4 g.

The result is a dispersion having a solids content of 25.5% by weight. The SiO₂ content is 20.8% by weight and the amount of protected isocyanate groups in the dispersion is 0.17 mmol/g. The dispersion is slightly turbid and exhibits a Tyndall effect.

### Synthesis Example 4

### Preparation of SiO₂ Nanosol Particles Modified with Blocked Isocyanate Groups

1.54 g of the diisopropylamine-protected isocyanato-silane (silane 2) prepared in synthesis example 2 are introduced. Then, over the course of 30 min, 20 g of an SiO₂ organosol (IPA-ST from Nissan Chemicals, 30% by weight SiO₂, 12 nm average particle diameter) are added dropwise and the pH is adjusted to 3.0 by addition of trifluoroacetic acid. The dispersion obtained is stirred at 60° C. for 3 h and then at room temperature for 24 h.

The resulting dispersion has a solids content (particle content) of 35% by weight, the SiO₂ content is 27.9% by weight, and the amount of protected isocyanate groups in the dispersion is 0.23 mmol/g. The dispersion is slightly turbid and exhibits a Tyndall effect.

### Examples 1-7

### Preparation of a 1K Coating Formulation Comprising SiO₂ Nanosol Particles Modified with Blocked Isocyanate Groups

To prepare an inventive coating formulation, an acrylate-based paint polyol having a solids content of 52.4% by weight (solvents: solvent naphtha, methoxypropylacetate (10:1)), a hydroxyl group content of 1.46 mmol/g resin solution, and an acid number of 10-15 mg KOH/g is mixed with Desmodur® BL 3175 SN from Bayer (butane oxime-blocked polyisocyanate, blocked NCO content of 2.64 mmol/g). The amounts of the respective components that are used can be found in table 1. Subsequently the amounts indicated in table 1 of the dispersions prepared in accordance with synthesis example 3 are added. In this case molar ratios of protected isocyanate functions to hydroxyl groups of 1.1:1 are achieved in each case. Furthermore, in each case, 0.01 g of a dibutyltin dilaurate and 0.03 g of a 10% strength by weight solution of ADDID® 100 from Tego AG (polysiloxane-based flow control assistant) in isopropanol are admixed, giving coating formulations having approximately 50% solids content. These mixtures, which initially are still slightly turbid, are stirred at room temperature for 48 h, giving clear coating formulations.

TABLE 1
Formulas of the coating materials
(Example 1-7)

| | Desmophen ® | Desmodur ® | Nanosol from | Particle |
|---|---|---|---|---|
| | A 365 BA/X | BL 3175 SN | Synth. Ex. 3 | content¹⁾ |
| Example 1* | 4.50 g | 2.73 g | 0.0 g | 0.0% |
| Example 2 | 4.50 g | 2.72 g | 0.30 g | 1.7% |
| Example 3 | 4.50 g | 2.71 g | 0.38 g | 2.2% |
| Example 4 | 4.50 g | 2.70 g | 0.57 g | 3.2% |
| Example 5 | 4.50 g | 2.69 g | 0.76 g | 4.2% |
| Example 6 | 4.50 g | 2.64 g | 1.52 g | 8.2% |
| Example 7 | 4.50 g | 2.60 g | 2.11 g | 11.2% |

*not inventive
¹⁾fraction of the particles (P) of synthesis example 3 as a proportion of the total solids content of the respective coating formulation

### Example 8

### Preparation of a 1K Coating Formulation Comprising SiO₂ Nanosol Particles Modified with Blocked Isocyanate Groups

To prepare an inventive coating, 4.50 g of an acrylate-based paint polyol having a solids content of 52.4% by weight (solvent: solvent naphtha, methoxypropyl acetate (10:1)), a hydroxyl group content of 1.46 mmol/g resin solution, and an acid number of 10-15 mg KOH/g are mixed with 2.71 g of Desmodur® BL 3175 SN from Bayer (butane oxime-blocked polyisocyanate, blocked NCO content of 2.64 mmol/g). Subsequently 0.29 g of the dispersion prepared in synthesis example 4 is added, containing diisopropyl-amine-blocked isocyanate-group-modified SiO₂ nanosol particles. This corresponds to a molar ratio of protected isocyanate functions to hydroxyl groups of 1.1:1. The amount of particles of synthesis example 4 as a proportion of the overall solids content is 2.2% by weight. Additionally, 0.01 g of a dibutyltin dilaurate and 0.03 g of a 10% strength by weight solution of ADDID® 100 from TEGO AG (polysiloxane-based flow control assistant) in isopropanol are mixed in, giving a coating formulation with a solids content of approximately 50% by weight. This mixture, which initially is still slightly turbid, is stirred at room temperature for 48 h, giving a clear coating formulation.

### Production and Evaluation of Coating Films From the Coating Formulations of Examples 1-8

The coating materials from examples 1-8 are each knife-coated onto a glass plate using a Coatmaster® 509 MC film-drawing device from Erichsen, with a knife having a slot height of 120 μm. Subsequently the coating films obtained are dried in a forced-air drying chamber at 70° C. for 30 minutes and then at 150° C. for 30 min. Both from the coating formulations of the examples and from the comparative examples, coatings are obtained which are visually flawless and smooth. The particles are located preferentially at the surface of the respective coating.

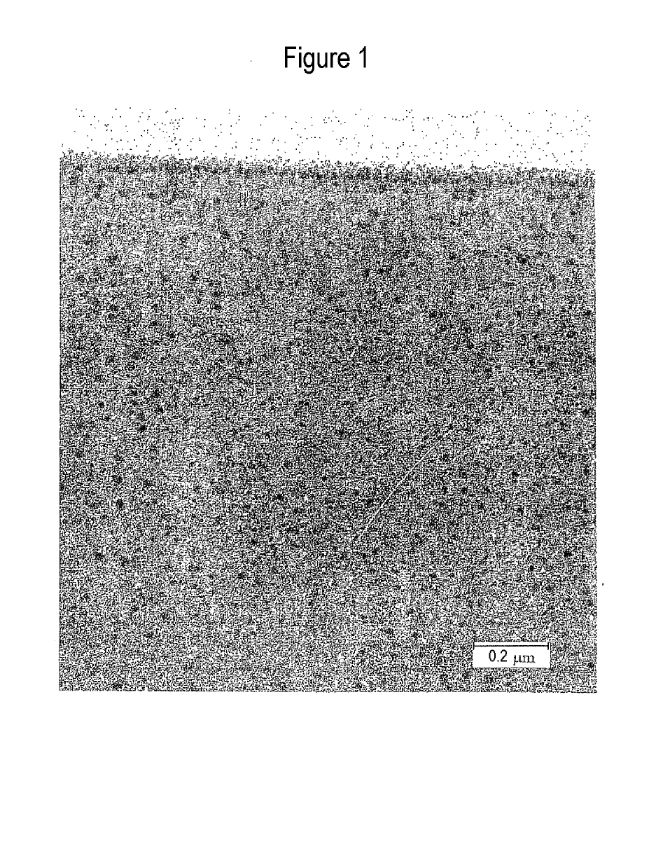

FIG. 1 shows a TEM micrograph of a vertical section through a coating produced from a coating formulation according to example 4. The accumulation of particles at the coating surface is clearly evident in this micrograph.

The gloss of the coatings is determined using a Micro gloss 20° gloss meter from Byk and for all of the coating formulations is between 159 and 164 gloss units. The scratch resistance of the cured coating films thus produced is determined using a Peter-Dahn abrasion-testing instrument. For this purpose a Scotch Brite® 2297 abrasive pad with an area of 45×45 mm is loaded with a weight of 500 g. Using this loaded pad, the coating specimens are scratched with a total of 40 strokes. Both before the beginning and after the end of the scratching tests, the gloss of the respective coating is noted using a Micro gloss 20° gloss meter from Byk. As a measure of the scratch resistance of the respective coating, the loss of gloss in comparison to the initial value is ascertained:

TABLE 2
Loss of gloss in the Peter-Dahn scratch test

| Coating sample | Loss of gloss |
|---|---|
| Example 1* | 72% |
| Example 2 | 30% |
| Example 3 | 32% |
| Example 4 | 27% |
| Example 5 | 29% |
| Example 6 | 32% |
| Example 7 | 25% |
| Example 8 | 30% |

*not inventive

The results show that even very small amounts of the particles (P) lead to a distinct increase in the scratch resistance of the coating in question. This is a direct consequence of the accumulation of the particles at the coating surface, since in this way even small amounts of particles are sufficient to achieve a high superficial particle density.

1-10. (canceled)

11. A coating (B) produced from a coating formulation (B1), comprising:
a) 20%-90% by weight, based on the solids fraction, of at least one film-forming resin (L) having reactive groups,
b) 0%-90% by weight, based on the solids fraction, of at least one coating curative (H) which possesses reactive functions which react, during curing of the coating material, with the reactive groups of the film-forming resin (L),
c) 0.05%-15% by weight, based on the solids fraction, of particles (P), and
d) 0%-90% by weight, based on the overall coating formulation (B1), of a solvent or mixture of solvents,
wherein
a) the cured coating (B) has, aa) on its surface or ab) in the near-surface layers which measured from the surface are 1000 nm thick, or ac) both on its surface and in the near-surface layers which measured from the surface are 1000 nm thick, a higher concentration of the particles (P) than in an interior portion of the coating, and wherein
b) the particles (P) are obtained by reaction of colloidal silicon dioxide sols (P1) containing particles having an average particle size of 1-100 nm, with at least one organosilane (A) of the formulae (I) and (II) 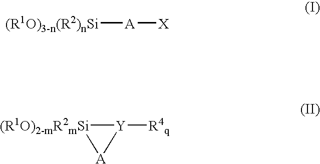
where
R¹ each individually denotes hydrogen or an alkyl, cycloalkyl or aryl radical having 1 to 6 C atoms, carbon chains of the alkyl, cycloalkyl, or aryl groups optionally interrupted by nonadjacent oxygen, sulfur or NR³ groups,
R² each individually denotes alkyl, cycloalkyl, aryl or arylalkyl radicals having 1 to 12 C atoms, carbon chains of the alkyl, cycloalkyl, aryl, or acrylalkyl groups optionally interrupted by nonadjacent oxygen, sulfur or NR³ groups,
R³ each individually denotes hydrogen or an alkyl, cycloalkyl, aryl, arylalkyl, aminoalkyl or aspartate ester radical,
R⁴ each individually denotes hydrogen or an organic radical,
A each individually denotes a divalent, optionally substituted alkyl, cycloalkyl or aryl radical having 1-10 carbon atoms, optionally interrupted by oxygen, sulfur or NR³ groups,
X each individually denotes an organic function which on curing of the coating is able to enter into a chemical reaction with functions of the film-forming resin (L) the curative (H), or both the film-forming resin (L) and the curative (H), and
Y each individually denotes an organic function which when the coating material is cured optionally after cleaving of the Si—Y bond, reacts with functions of the film-forming resin (L) the curative (H), or both the film-forming resin (L) and the curative (H), and
n is 0, 1 or 2,
m is 0, 1 or 2, and
q is 0 or 1.

12. A coating (B) of claim 11, produced from a coating formulation (B1) comprising:
a) 30%-80% by weight, based on the solids fraction, of the film-forming resin (L),
b) 5%-60% by weight, based on the solids fraction, of the coating curative (H),
c) 0.1%-12% by weight, based on the solids fraction, of particles (P), and
d) 0%-70% by weight, based on the overall coating formulation (B1), of a solvent or mixture of solvents.

13. The coating (B) of claim 11, wherein groups R¹ in the organosilane(s) (A) are methyl or ethyl radicals.

14. The coating (B) of claim 11, wherein groups X in the organosilane(s) (A) of the formula (I) are a hydroxyl or thiol function, a group of the formula NHR⁵, a heterocyclic ring containing an NH function, or an epoxide function, where R⁵ has the definition of R³.

15. The coating (B) of claim 11, wherein the groups Y in the organosilane(s) (A) of the formula (II) are a function which, following the cleavage of the Si—Y bond, comprises a hydroxyl or thiol function or a group of the formula NHR⁵ where R⁵ has the definition of R³.

16. The coating (B) of claim 11, wherein at least one organosilane (A) has the formulae (III) or (IIIa) 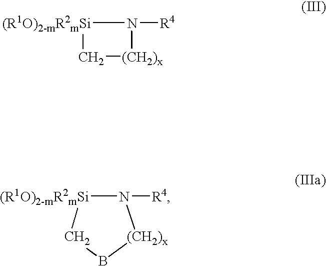
where
B is an oxygen atom, a sulfur atom, a carbonyl group, an ester group, an amide group or a group NR⁶,
R⁶ has the definition of R³, and
x is from 0 to 10.

17. The coating (B) of claim 11, wherein the film-forming resins (L) comprise hydroxyl-containing polyacrylates or hydroxyl-containing polyesters.

18. The coating (B) of claim 11, wherein the coating curative (H) contains free or protected isocyanate groups.

19. The coating (B) of claim 12, wherein at least one organosilane (A) is 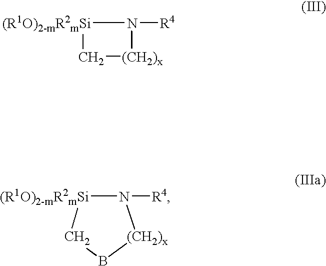
wherein
B is oxygen, sulfur, carbonyl, an ester group, an amide group, or a group NR⁶ where R⁶ has the definition of R³, and
x is from 0 to 10.

20. The coating (B) of claim 11, wherein at least one organosilane (A) is 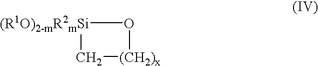 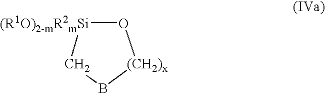
wherein
B is oxygen, sulfur, carbonyl, an ester group, an amide group, or a group NR⁶ where R⁶ has the definition of R³, and
x is from 0 to 10.

21. The coating (B) of claim 11, wherein at least one organosilane (A) is 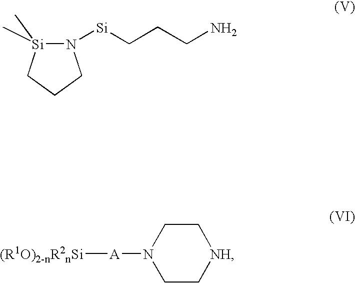
wherein
B is oxygen, sulfur, carbonyl, an ester group, an amide group, or a group NR⁶ where R⁶ has the definition of R³, and
x is from 0 to 10.

22. The coating (B) of claim 11, wherein the particles (P1) are further functionalized with one or more of a silane (S1) other than an organosilane (A), a silazane (S2) other than an organosilane (A), and a siloxane (S3).

23. The coating (B) of claim 22, wherein from 50% to 90% by weight of functional groups on particles (P1) are derived from one or more organosilanes (A).

24. The coating (B) of claim 11, wherein the particles (P1) are functionalized with a blocked isocyanate, one of the reactive groups of the film forming resin (L) or of the curative (H) is a blocked isocyanate group, and wherein the elimination temperature of the blocked isocyanate groups of the particles (P1) or at least a majority of particles (P1) is less than the elimination temperature of the blocked isocyanate groups of the film forming resin (L) or the curative (H).

25. The coating (B) of claim 11, wherein at least one population of particles (P1) are functionalized with an organosilane (A) where A is methylene.
